(19) United States
(12) Patent Application Publication
(10) Pub. No.: US 2022/0258861 A1
(43) Pub. Date: Aug. 18, 2022

(54) DRONE AND METHOD FOR CONTROLLING THE ATTITUDE THEREOF

(71) Applicants: E-NOVIA S.P.A., Milano (IT); POLITECNICO DI MILANO, Milano (IT)

(72) Inventors: Lorenzo Mario FAGIANO, Bologna (IT); Glauco BIGINI, Milano (IT); Mattia DE SANTIS, Paullo (IT)

(73) Assignees: E-NOVIA S.P.A., Milano (IT); POLITECNICO DI MILANO, Milano (IT)

(21) Appl. No.: 17/596,766

(22) PCT Filed: Jun. 17, 2020
(86) PCT No.: PCT/IB2020/055632

§ 371 Date: Dec. 17, 2021

(30) Foreign Application Priority Data
Jun. 19, 2019 (IT) 102019000009522

(51) Int. Cl. B64C 39/02; B64D 27/24; B66D 1/74

(52) U.S. Cl. CPC B64C 39/022; B64C 39/024; B64D 27/24; B64C 2201/141; B64C 2201/027; B64C 2201/042; B64C 2201/108; B66D 1/7489

(57) ABSTRACT

Drone (5) which comprises a plurality of propellers (16) driven by motors (17) supported by at least one structure (18) with a winch (8) provided with a drum which can rotate by means of a motor (22) to unwind or wind a suspended cable (6), characterized in that the structure (18) comprises a central seat (19) in which the winch (8) is arranged, so that the center of mass of the drone (5) falls into the drum of the winch (8). The present description also relates to a method of controlling the attitude of the drone (5).

### TECHNICAL FIELD

The present description relates to a drone, in particular a multi-rotor drone with a winch for a suspended electric cable. The present description also relates to a method of controlling the attitude of the drone.

### BACKGROUND OF THE DESCRIPTION

One or more drones can be connected to each other by electric cables in different possible configurations, in which at least one drone is connected to a base station capable of supplying electricity. Such drone networks may be used to perform different types of tasks in civil applications, such as monitoring via cameras. A drone can be equipped with a winch on which a suspended electric cable can be wound and unwound, in order to adjust its length.

For example, FR 3037448 A1, FR 3033256 A1, FR 3053259 A1 and US 2016/0083115 A1 describe drone networks equipped with a ground winch and voltage converters on the ground and on board the drones, to raise the level of electrical voltage on the cable and thus decrease the current transmitted at a same power, with a consequent reduction in the diameter and mass of the cable. These drones are also equipped with control systems that regulate the force on the cable and limit the maximum length of the cable being unwound, leaving free the possibility of rewinding. However, these known control systems have the relevant drawback of constraining the drone's ability to maneuver, effectively limiting their movement to only the vertical direction with respect to the base station. This constraint is mainly due to the considerable risk that the suspended cable will get caught in obstacles and constitute an obstacle for people and things near the base station. To overcome this drawback, while maintaining the advantage of supplying power by cable, drone networks are known, connected by electric cables in different possible configurations so as to provide greater maneuvering capacity, keeping the formation geometry under control and consequently keeping under control the positioning of each suspended cable segment.

For example, US 2013/0233964 A1 describes drone networks equipped with winches to adjust the length of the electric cables, US 2016/0144958 A1 describes safety devices that act in the event of interruption of electrical connection in drone networks, for example because of a failure in one of the suspended cables, and the article “Systems of Tethered Multicopters” by L. Fagiano, published in the scientific journal IFAC-PapersOnLine, volume 50, issue 1, July 2017, pages 4610-4615, describes drone networks connected by suspended cables, where each drone can be equipped with a winch controlled by a system that regulates the length of the cable connected to the next drone. The article proposes a control system partly centralized and partly distributed to optimally adjust the length of the cables and the motion of drones, respecting operational constraints and pursuing a predetermined task.

A problem with such drone systems relates to the effect of mechanical forces applied by cables, which generally generate translation forces and moments on each drone. These forces must be balanced by a system that regulates the attitude and position of each drone through an additional effort of the rotors, with consequent potential problems for the stability of the motion of the drone.

A further problem relates to the additional mass and size of the voltage conversion system on board each drone, which also requires a cooling system to keep the converter temperature within acceptable limits. These masses and sizes must be minimized to reduce energy required by each drone and to make possible to use networks with a greater number of drones and longer cables.

The document US2008006737, on the disclosure of which the preamble of each independent claim is based, describes an aircraft having a plurality of rotors each connected to a respective motor, in which the motors are connected to each other by connection bars.

The document WO2016121072 describes a drone with a stable flight attitude, which allows to perform a given work and in which a sudden change of the load or the severing of a power cable does not cause the fall of the drone.

The document US2017222594 discloses an intelligent control system for driving motors of a drone, comprising a temperature detection unit, a processing unit and an output power control unit of the motor. The processing unit can be configured to compare whether the detected temperature exceeds a first particular temperature and to control the output power of the engine to dynamically adjust a maximum output power of the various motors according to a result of the comparison.

The document US2019106212 discloses a system of drones and a ground station which is connected to at least a drone, wherein each drone is equipped with a lateral cable connected to the station or to another drone, and to a mechanism that provides or pulls the lateral cable.

### SUMMARY OF THE DESCRIPTION

A goal of the present description is thus to provide a drone free from such limitations. Said goal is achieved with a drone and a drone control method, whose main features are specified in the enclosed claims.

If provided with a particular winch integrated in the central structure, the drone according to the present description can bring the cable suspended at its center of mass to minimize moments due to the forces on the cable, as well as to decrease the additional mass due to the winch. The control method may further imparts an appropriate separate command action to the motors of the drone, so that the thrust difference between the different propellers generate a rotational torque that balances in an automatic way the torque caused by the engine that operate the winch. In this way, the impact of the winch movement on the drone's structure is minimized, also reducing the energy required to counterbalance the effects of the forces applied by the cables on the drone.

The drone may further comprise a particular energy transmission system in which the voltage conversion system for the propeller motors is split into several converters designed in an integrated way with respect to the motors, so as to reduce the power managed by each converter, naturally provide each converter with a consistent flow of air through the propellers, and distribute the additional mass of the converters uniformly with respect to the center of mass of the drone, so as to further improve the stability of the drone. Since the converters are arranged under the propellers of the drone, the greater the power required by the propeller, the greater the flow of cooling air. The use of a plurality of converters having a reduced mass, each dedicated to a motor and propeller system, allows to distribute in a homogeneous way the overall sizes and the masses, freeing also space in the central part of the drone for housing the winch and/or the payload of the drone, for example, a video and image collection device, thus creating a synergistic effect with the aforementioned method of controlling the attitude in function of the rotation of the winch.

In addition, the use of a plurality of converters provides redundancy that increases safety of the drone, since in the event of a converter failure it is possible to isolate the relative part of the electrical system and continue the flight with the remaining converters, alternatively by deactivating other motors selectively to balance the attitude of the drone.

The present description also relates to an automatic method for regulating the temperature of the converters on board each drone, which varies the working load of each motor so as to avoid excessive temperatures in the converters and in the motors.

### BRIEF DESCRIPTION OF THE DRAWINGS

Further advantages and characteristics of the drone and of the method according to the present description will become apparent to those skilled in the art from the following detailed and non-limiting description of an embodiment thereof, referring to the accompanying drawings in which:

FIG. 1 shows a schematic view of a drone network with a base station on the ground;

FIG. 2 shows a schematic view of a drone network with a suspended base station;

FIG. 3 shows a perspective view of the drone;

FIG. 4 shows a schematic transverse sectional view of the drone of FIG. 3;

FIG. 5 shows a block diagram of a first control system of the drone of FIG. 3;

FIG. 6 shows a schematic side view of the drone of FIG. 3;

FIG. 7 shows a block diagram of a second drone control system of FIG. 3.

### EXEMPLARY EMBODIMENTS

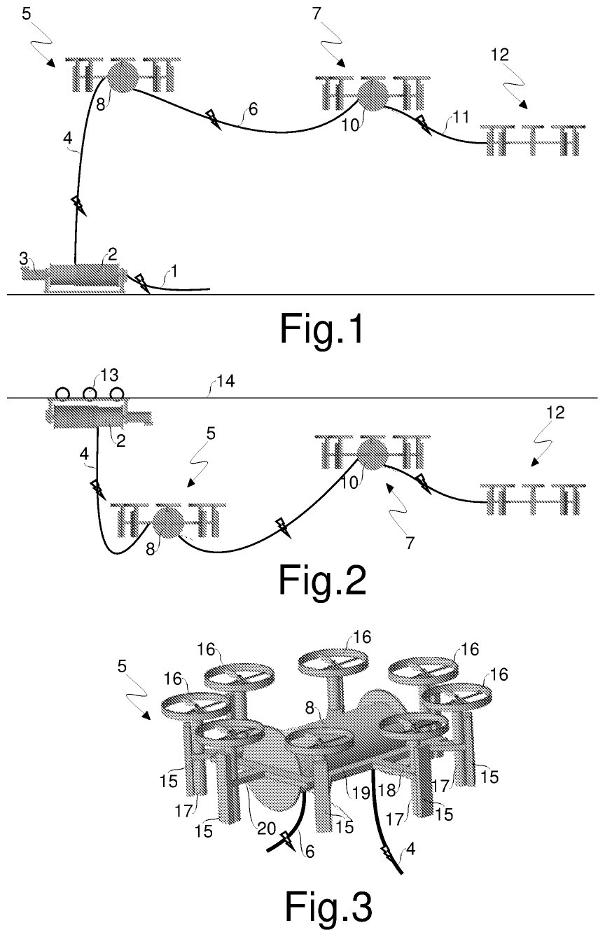

Referring to FIG. 1, it is seen that a drone network, in particular multi-rotor propeller electric drones, may comprise a power cable 1 which is electrically connected to a base winch 2, which can be fixed to the ground. The power cable 1 can supply the base winch 2 with electricity from electric mains, a generator or an accumulator of electricity. An auxiliary cable 4 is wound on the base winch 2 and is connected, at the opposite end, to a first drone 5. The base winch 2 is equipped with a device, for example by means of sliding contact rings, designed to guarantee continuity of the transmission of energy between the power cable 1 and the auxiliary cable 4 even during the rotation of the drum of the base winch 2. In this way, the auxiliary cable 4 can continuously supply electricity to the first drone 5. A control system 3 comprises a control unit for controlling the operation of an electric motor of the drum of the base winch 2. The first drone 5 can be connected via a suspended cable 6 to a second drone 7. The first drone 5 is equipped with at least one winch 8, on which the suspended cable 6 is wound. The suspended cable 6 may supply electrical energy and/or control signals to the second drone 7, which in turn can be equipped with a winch 10, on which a further suspended cable 11 is wound to supply electrical energy to a third drone 12, which in the present example is the last of the series and thus preferably does not include an on board winch. Drone 5 can also be the only drone in the system and/or have the auxiliary cable 4 wound on the winch 8.

Referring to FIG. 2, it can be seen that in a drone network similar to that of FIG. 1 the base winch 2 can be mounted on a mobile support 13 which can move and/or rotate with respect to a structure 14 which maintains the mobile support 13 suspended from the ground and for example constituted by one or more suspended cables, as shown in the figure, or by the frame of an infrastructure, by the arm of a crane or by other equipment, provided in turn with degrees of freedom of rotation or translation.

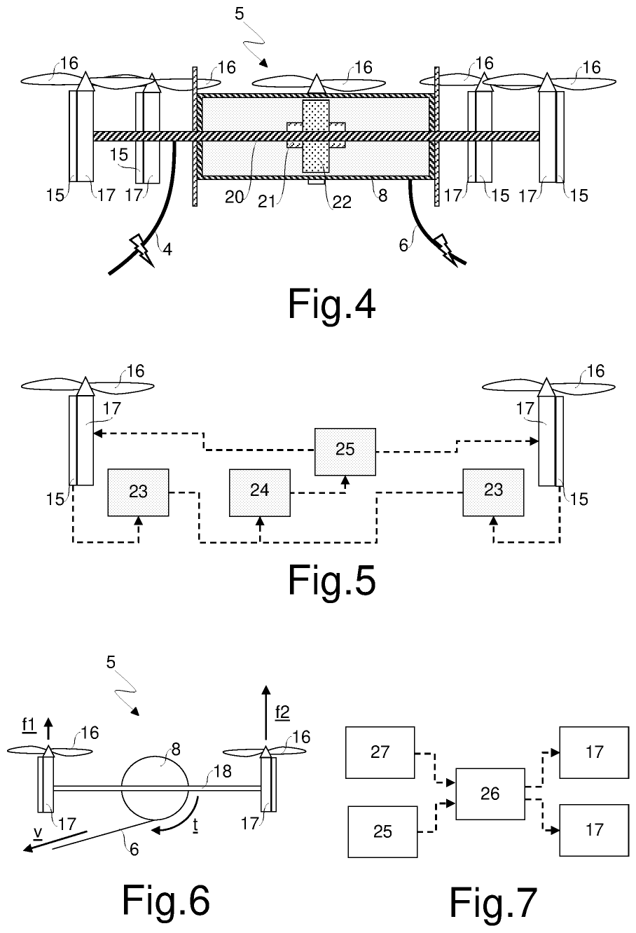

Referring to FIGS. 3 and 4, it can be seen that the drone 5 comprises a plurality of converters 15 capable of converting high voltage electric energy (for example about 1000 V DC), received by the auxiliary cable 4, into low voltage electric energy (e.g. 24 V DC or 48 V DC). The drone 5 further comprises a plurality of propellers 16 driven by motors 17 which are powered by such low voltage electricity and are supported by at least one structure 18, in particular comprising at least one frame formed of a plurality of elements joined together. The converters 15 are arranged around the structure 18, preferably fixed to the motors 17 and/or under the propellers 16, i.e. under a vertical projection of the dimensions of the propellers 16, in the horizontal flight position of the drone 5. Preferably, each converter 15 supplies electrical energy to the motor 17 which drives the propeller 16 under which the converter 15 is arranged, so that the drone 5 comprises a same number of converters 15 and motors 17. Alternative embodiments may include a smaller number of converters 15, each of which feeds multiple motors 17, for example four or two converters 15 for a drone with eight propellers 16. At least two converters 15 can be arranged in opposite positions with respect to the structure 18, preferably at substantially equal distances from the center of mass of the drone 5, so that the center of mass of these at least two converters 15 falls into the drum of the winch 8 and/or substantially coincides with the center of mass of the drone 5.

The structure 18 may comprise a central seat 19, in particular defined by a portion of the frame having a substantially rectangular shape, in which the winch 8 is arranged, which carries the suspended cable 6 and which may rotate around a shaft 20 arranged in the central seat 19. The shaft 20 preferably extends outside the central seat 19 for connecting between them two motors 17 arranged in opposite positions with respect to the structure 18. The center of mass of the drone 5 preferably falls into the drum of the winch 8, in particular in a position substantially coinciding with the center of mass of the winch 8. The winch drum 8 is preferably hollow for housing certain components of the drone 5, in particular a central control unit 21 of the drone 5 and the motor 22 of the winch 8, disposed between the shaft 20 and the drum, so as to optimize the use of space and to balance the drone 5.

FIG. 5 shows a control system of the drone 5 to reduce the thermal stress of the converters 15 and of the motors 17, maintaining the flight stability of the drone 5, which system comprises temperature sensors 23 arranged in correspondence with the converters 15 and/or with the motors 17 to transmit temperature data to a temperature control unit 24, which analyzes the distribution of temperatures measured by the temperature sensors 23 and calculates data variation of the rotation speed of the motors 17, i.e. of their lift forces f1 . . . fn, in order to balance the temperatures, for example by raising the lower ones and lowering the higher ones, without changing the flight attitude of the drone 5. This method can be performed when the drone 5 is equipped with more than four motors 17 and propellers 16, so that there are more possible speed combinations of each propeller 16 that produce a same combination of lift forces and of torques applied to drone 5, preferably including the torque caused by the winch 8. The temperature control unit 24 sends calculated speed change data to a flight control unit 25, which varies the speed of the motors 17 accordingly.

FIG. 6 shows the effect on the attitude of the drone 5 of the torque t applied by the motor 22 to operate the winch 8, for example when the suspended cable 6 must be unrolled with a certain speed v. To carry out this operation, the motor 22 drives the winch 8 with a torque t which would cause an unwanted pitching of the drone 5. To balance this pitch, the drone 5 varies the speed of the motors 17 to vary the lift forces f1 . . . fn of the propellers 16 and thus generate a pitch torque equal to and opposite to the torque t. In particular, one or more lift forces f1 . . . fn of the propellers 16 are increased or decreased to wind or unwind the suspended cable 6.

FIG. 7 shows a control system of the attitude of the drone 5 to balance the rotation of the winch 8, which system comprises a control unit of the attitude 26 which receives as input information data of the torque t transmitted by unit of control of the winch 27 and data of the speeds of the motors 17 transmitted by the flight control unit 25. In the method according to the present embodiment, the control unit of the attitude 26 calculates a variation of speed of the propellers 16 concerned, for example the two propellers 16 of FIG. 6 is placed along a direction perpendicular to the axis of rotation of the winch 8, so that the relative lift forces f1 and f2 balance the torque t, as described above, and send the resulting varied speed data to the motors 17 of the two propellers 16. If the direction perpendicular to the axis of rotation of the winch 8 does not coincide with the position of two propellers 16, the control unit of the attitude 26 acts on a greater number of propellers 16, so as to have anyway a torque at the center of mass of the drone 5 which balances the torque t.

The temperature control unit 24 and/or the control unit of the flight 25 and/or the control unit of the attitude 26 and/or the control unit of the winch 27 can be implemented in a known manner in at least a single electronic control unit, preferably arranged in the central control unit 21 of the drone 5.

Any variants or additions may be made by skilled persons to the embodiment described herein and illustrated remaining within the scope of the following claims. In particular, further embodiments may include the technical characteristics of one of the following examples with the addition of one or more technical characteristics described in the text or illustrated in the drawings, taken individually or in any mutual combination.

### EXAMPLES

1. A drone (5) which comprises a plurality of propellers (16) driven by motors (17) supported by at least one structure (18) with a winch (8) provided with a drum which can rotate by means of a motor (22) to unwind or winding a suspended cable (6), characterized in that the structure (18) comprises a central seat (19) in which the winch (8) is arranged, so that the center of mass of the drone (5) falls into the drum of the winch (8).

2. The drone (5) according to the previous example, characterized in that the center of mass of the drone (5) substantially coincides with the center of mass of the winch (8).

3. The drone (5) according to one of the preceding examples, characterized in that the motor (22) suitable to rotate the drum of the winch (8) is arranged in the drum.

4. The drone (5) according to one of the preceding examples, characterized in that the structure (18) comprises a frame formed by a plurality of elements which are joined together, wherein the central seat (19) of the winch (8) is defined by a portion of the frame having a substantially rectangular shape.

5. The drone (5) according to one of the preceding examples, characterized in that the drum of the winch (8) is configured to rotate around a shaft (20) which extends outside the central seat (19) to connect to each other two motors (17) arranged in opposite positions with respect to the structure (18).

6. The drone (5) according to one of the preceding examples, characterized by comprising a plurality of converters (15) arranged around the structure (18) for converting high voltage electrical energy into low voltage electrical energy, wherein the center of mass of the converters (15) falls into the drum of the winch (8).

7. The drone (5) according to one of the preceding examples, characterized by comprising an attitude control unit (26) connected to the motors (17) and to a winch control unit (27), in which the attitude control unit (26) is suitable to vary the speed of the motors (17) according to data of the torque (t) acting on the winch (8) transmitted by the winch control unit (27) to the attitude control unit (26).

8. The drone (5) according to the previous example, characterized in that the attitude control unit (26) acts on the motors (17) to determine a speed variation of two or more propellers (16), so that the relative lift forces (f1 . . . fn) balance the effects of the torque (t) exerted by the motor (22) of the winch (8).

9. The drone (5) according to one of the preceding examples, characterized in that it comprises temperature sensors (23) which are arranged at the converters (15) and/or the motors (17) to transmit temperature data to a temperature control unit (24), which is suitable to calculate variation data of the rotation speed of the motors (17), which are sent to a flight control unit (25), according to the temperature data received from the temperature sensors (23).

10. The drone (5) according to one of examples 7 to 9, characterized in that the temperature control unit (24) and/or the flight control unit (25) and/or the attitude control unit (26) and/or the winch control unit (27) are arranged in a central control unit (21) of the drone (5).

11. The drone (5) according to the previous example, characterized in that the central control unit (21) is arranged in the drum of the winch (8).

12. A method for controlling the attitude of a drone (5) which comprises a plurality of propellers (16) driven by motors (17) supported by at least one structure (18) with at least one winch (8) provided with a drum which can rotate by means of a motor (22) to unwind or wind a suspended cable (6), characterized in that it comprises the following operating steps:
determining the torque (t) exerted by the motor (22) on the drum of the winch (8);
calculating variations of the lift forces (f1 . . . fn) of the propellers (16) according to said torque (t);
varying the rotation speed of the motors (17) according to said calculation, so as to vary the lift forces (f1 . . . fn) of the respective propellers (16).

13. The method according to the previous example, characterized in that it comprises the following further operative steps:
measuring temperatures at the motors (17) by means of temperature sensors (23);
calculating variations of the lift forces (f1 . . . fn) of the propellers (16) according to said measured temperatures;
varying the rotation speed of the motors (17) according to said calculation, so as to vary the lift forces (f1 . . . fn) of the respective propellers (16).

1. A drone which comprises a plurality of propellers driven by motors supported by at least one structure with a winch provided with a drum which can rotate by means of a motor to unwind or winding a suspended cable, wherein the structure comprises a central seat in which the winch is arranged, so that the center of mass of the drone falls into the drum of the winch, characterized in that the drum of the winch is suitable to rotate around a shaft which extends outside the central seat to connect to each other two motors arranged in opposite positions with respect to the structure.

2. The drone according to claim 1, characterized in that the center of mass of the drone substantially coincides with the center of mass of the winch.

3. The drone according to claim 1, characterized in that the motor suitable to rotate the drum of the winch is arranged in the drum.

4. The drone according to claim 1, characterized in that the structure comprises a frame formed by a plurality of elements which are joined together, wherein the central seat of the winch is defined by a portion of the frame having a substantially rectangular shape.

5. The drone according to claim 1, characterized by comprising a plurality of converters arranged around the structure for converting high voltage electrical energy into low voltage electrical energy, wherein the center of mass of the converters falls into the drum of the winch.

6. The drone according to claim 1, characterized by comprising an attitude control unit connected to the motors and to a winch control unit, in which the attitude control unit is suitable to vary the speed of the motors according to data of the torque acting on the winch transmitted by the winch control unit to the attitude control unit.

7. The drone according to claim 6, characterized in that the attitude control unit acts on the motors to determine a speed variation of two or more propellers, so that the relative lift forces balance the effects of the torque exerted by the motor of the winch.

8. The drone according to claim 1, characterized in that it comprises temperature sensors which are arranged at the converters and/or the motors to transmit temperature data to a temperature control unit, which is suitable to calculate variation data of the rotation speed of the motors, which are sent to a flight control unit, according to the temperature data received from the temperature sensors.

9. The drone according to claim 6, characterized in that the temperature control unit and/or the flight control unit and/or the attitude control unit and/or the winch control unit are arranged in a central control unit of the drone.

10. The drone according to claim 9, characterized in that the central control unit is arranged in the drum of the winch.

11. A method for controlling the attitude of a drone which comprises a plurality of propellers driven by motors supported by at least one structure with at least one winch provided with a drum which can rotate by means of a motor to unwind or wind a suspended cable, characterized in that it comprises the following operating steps:
determining the torque exerted by the motor on the drum of the winch;
calculating variations of the lift forces of the propellers according to said torque;
varying the rotation speed of the motors according to said calculation, so as to vary the lift forces of the respective propellers.

12. A method according to claim 11, characterized in that it comprises the following further operative steps:
measuring temperatures at the motors by means of temperature sensors;
calculating variations of the lift forces of the propellers according to said measured temperatures;
varying the rotation speed of the motors according to said calculation, so as to vary the lift forces of the respective propellers.
